(19) United States
(12) Patent Application Publication
(10) Pub. No.: US 2005/0275177 A1
(43) Pub. Date: Dec. 15, 2005

(54) Folding storage assembly

(76) Inventor: Michael E. Buckley, III, Chantilly, VA (US)

Correspondence Address: DIEDERIKS & WHITELAW, PLC, 12471 Dillingham Square, #301, Woodbridge, VA, 22192, US

(21) Appl. No.: 10/926,975

(22) Filed: Aug. 27, 2004

Related U.S. Application Data
(60) Provisional application No. 60/574,675, filed on May 27, 2004.

(51) Int. Cl. B62B 11/00

(52) U.S. Cl. 280/47.34

(57) ABSTRACT

According to a preferred embodiment of the invention, a folding storage assembly includes a first panel is pivotally connected to a second panel. In addition, a third panel is pivotally connected to the first panel. Flexible side panels are attached to the pivoting panels. The folding storage assembly is movable between an in-use position and a stowed position. Moreover, the storage assembly may include at least one fastening member for fastening the assembly to a bracket which is adapted to be secured to a lumber cart. Therefore, the invention provides a folding storage assembly that can easily be fastened to a cart and can be secured in an open or stowed position to accommodate the needs of a shopper and will not allow small articles to fall out of the assembly.

### CROSS-REFERENCE TO RELATED APPLICATION

The present application claims the benefit of U.S. Provisional Patent Application Ser. No. 60/574,675 filed May 27, 2004.

### BACKGROUND OF THE INVENTION

1. Field of the Invention

The present invention pertains to a folding storage assembly for protecting fragile items in shopping carts, such as those found in a store.

2. Discussion of the Prior Art

Shopping carts are widely known in the art and generally include a frame, a basket, wheels, and a handle for pushing the cart. The average shopper is buying more fresh produce than in years past, yet grocery carts remain the same with one large storage compartment. The large storage compartment typically has a limited size child seat, used in most cases to transport a child or a shopper's personal belongings. Shoppers without children often place fragile items, such as produce, in the child seat in order to protect them from heavier items. However, because of the limited size of the child seat, the majority of the produce is placed inside the grocery cart, thereby causing the shopper to risk damage or to constantly relocate the produce to prevent damage as heavier items are placed in the grocery cart. Further, most grocery stores are designed so the shopper begins shopping in the produce department. While the layout of grocery stores may make the store more appealing by stimulating the senses of shoppers, the layout also increases the risk of produce being crushed by heavier items placed in the cart as the shopper moves through the remaining aisles of the supermarket. To compound the problem, many stores have invested in large numbers of shopping carts and are reluctant to replace their entire fleet of carts to meet this new need because of the large cost involved.

Various attempts have been made to provide shoppers with an alternative storage space in a shopping cart. For example, U.S. Pat. No. 5,002,292 discloses an enclosure for storing items in a shopping cart positioned along the front wall of the shopping cart's basket. The enclosure includes at least two elongated panels positioned for mutual contact between the side walls of the basket. In addition, at least one of the panels is hinged to allow pivotal movement of the panel, thereby providing access to the enclosure. While the enclosure of the '292 patent provides an alternative area for storing items during shopping, the enclosure is not capable of folding to a stowed position. The inability to fold the enclosure to a stowed position is a disadvantage because there are times when a shopper wishes to utilize all of the cart space without being restricted by permanent fixtures in the cart.

In addition, various attempts have been made to provide a folding storage arrangement in a shopping cart. For example, U.S. Pat. Nos. 2,662,661 and 2,689,133 disclose a pivoting partition for use in a shopping cart. More specifically, the partition, which is pivotally attached to the floor of the shopping cart and is capable of moving between an upright and an inclined position, forms a storage area in the front of the shopping cart. The partition can also be moved along a guideway in order to increase or decrease the size of the storage area. However, even when the partition is in its upright position and the storage area is at its smallest, a division of the cart space exists. In addition, the partition and the cart basket are manufactured as one unit, therefore the folding storage arrangement is not adapted to fit into preexisting shopping carts.

In another more successful attempt to provide a folding storage arrangement in a shopping cart, the inventor of the present invention has proposed a folding storage assembly positioned adjacent the front wall of a cart basket including a first, a second and a third panel. As such, the folding storage assembly can be easily fastened to a cart basket and can be secured in an open or stowed position to accommodate the needs of a shopper. See U.S. Pat. No. 6,565,102 which is incorporated herein by reference. Indeed the folding storage assembly mentioned in the '102 patent does work exceptionally well especially in grocery shopping carts. However, there still exists a need for a such a storage assembly in other types of shopping carts such as a lumber cart or a flat cart which might be used in warehouse type stores for selling housing supplies or warehouse stores selling large items for home use. It is difficult to retain small items within the folding storage assembly so that they do not fall out of the folding storage assembly and thus the shopping cart because such lumber carts and flat carts are do not typically have side walls. Also in such shopping carts the mounting of the folded storage assembly becomes a problem because there may not be a back side to the cart.

Based on the above there still exists a need in the art for a folding storage assembly for storing fragile items in a shopping cart which can easily be folded into a stowed position when not in use. In addition, there exists a need for a folding storage assembly that can be manufactured inexpensively and be able to retrofit existing shopping carts. Further, there exists a need for a folding storage assembly that has some mechanism for preventing small items from falling out of the storage assembly and that can be mounted in various different types of shopping carts such as lumber carts and flat carts.

### SUMMARY OF THE INVENTION

The present invention is preferably directed to a folding storage assembly for holding items inside a shopping basket. When in a deployed or in-use position, the assembly provides a storage area for holding fragile items. The assembly is easily stowed in an upright position to accommodate larger items when the assembly is not in use. The assembly is designed to prevent small items from falling out of the assembly and may be mounted to a multitude of cart types.

According to a preferred embodiment of the invention, the folding storage assembly includes a first panel having first and second end portions, a second panel having first and second end portions, and a third panel having first and second end portions. The first panel is pivotally connected to the second panel. In addition, the third panel is pivotally connected to the first panel. The folding storage assembly is movable between an in-use position and a stowed position. In the in-use position, the first panel extends laterally from the second end portion of the third panel and the second panel projects upward from the second end portion of the first panel. In the stowed position, the first and second panels are positioned substantially flush with the third panel.

In accordance with a preferred embodiment of the invention, the folding storage assembly is adapted to be held in the in-use position or in the stowed position. The assembly may include a detent mechanism for holding the first and second panels substantially flush with the third panel. The detent mechanism holds the assembly in a stowed position, thereby allowing a shopper to use the entire cart basket. In addition, the assembly may include at least one connection member having a first end pivotally attached to the second end portion of the second panel and a second end attached to the third panel for pivotal movement relative to the third panel. The connection member prevents the second panel from folding when the assembly is in the in-use position. Moreover, the storage assembly may include at least one fastening member for fastening the assembly to the front wall of a basket. Therefore, the invention provides a folding storage assembly that can easily be fastened to an existing cart basket and can be secured in the in-use position or the stowed position to accommodate the needs of a shopper.

Also, in accordance with a preferred embodiment of the invention, the storage assembly includes flexible side panels provided to retain items within the storage assembly, thus creating a self-contained basket. The flexible side panels preferably extend between the various three panels of the folding storage assembly. One flexible side panel is located on each side of the assembly. Additionally, one or more mounting brackets may be attached to the first panel. Each mounting bracket is provided with a fastener member for fastening the bracket to the cart. For example, the fastening member may be formed as a hook so that it may hook over a rail typically found on a lumber cart.

Additional objects, features and advantages of the invention will become more readily apparent from the following detailed description of preferred embodiments thereof. When taken in conjunction with the drawings wherein like reference numerals refer to corresponding parts in several views.

### BRIEF DESCRIPTION OF THE DRAWINGS

FIG. 1 is a perspective view of the folding storage assembly, according to a preferred embodiment of the present invention, mounted inside a cart basket.

FIG. 2 is a side view of the folding storage assembly, according to a preferred embodiment of the present invention, mounted inside a cart basket.

FIG. 3 is an expanded view of the folding storage assembly of FIG. 1.

FIG. 4 is an enlarged perspective view of the folding storage assembly of FIG. 1 in an in-use position.

FIG. 5 is an enlarged side view of the folding storage assembly of FIG. 1 in a stowed position.

FIG. 6 is a perspective view of the folding storage assembly mounted on a lumber cart with a mounting bracket.

FIG. 7 is a close up perspective view of the mounting bracket shown in FIG. 6.

### DETAILED DESCRIPTION OF THE PREFERRED EMBODIMENTS

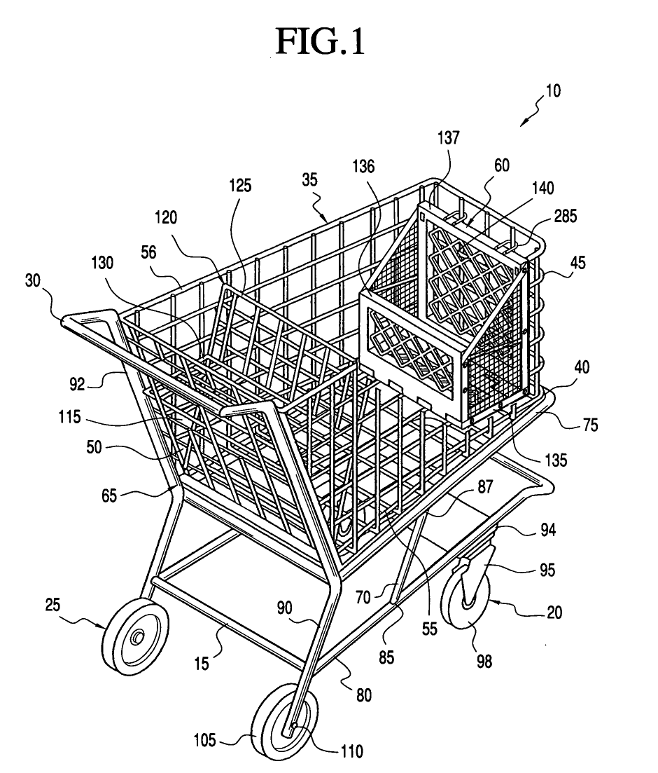

With initial reference to FIG. 1, a shopping cart is generally indicated at 10. As shown, the cart 10 includes a frame 15, a pair of front wheel assemblies 20 (only one shown) and a pair of rear wheel assemblies 25 supporting the frame 15, a handle 30 attached to the frame 15, and a basket 35, for holding items (not shown), attached to the frame 15. The basket 35 includes a floor 40, and spaced apart front 45, rear 50 and opposing side walls 55 and 56, which are interconnected and extend upward from the floor 40. In addition, the cart 10 includes a folding storage assembly 60, in accordance with a preferred embodiment of the invention, mounted in the basket 35 for holding items.

The frame 15 of the cart 10 includes the handle 30, a pair of upstanding tubular support members 65, a pair of intermediate tubular support members 70, a four-sided bottom tubular support member 75, and a U-shaped base portion 80. More specifically, the frame 15 is formed of the U-shaped base portion 80, which is attached to a first end 85 of each member of the pair of intermediate tubular support members 70. In addition, the U-shaped base portion 80 is attached to each member of the pair of upstanding tubular support members 65. A second end 87 of each member of the pair of intermediate support members 70 is attached to the four-sided bottom tubular support member 75, which is substantially parallel to the U-shaped base portion 80. Each member of the pair of intermediate tubular support members 70 forms an acute angle with the U-shaped base portion 80. The pair of upstanding tubular support members 65 are each formed of a unified tubular member bent into portions including a first portion 90 and an intermediate portion 92. The first portion 90 of each member of the pair of upstanding tubular support members 65 is attached to one of the rear wheel assemblies 25 at one end, then each first portion 90 extends at an angle towards the front wall 45 of the cart basket 35 until reaching the four-sided bottom tubular support 75. Each of the upstanding tubular support members 65 then bends away from the front wall 45 of the cart 10 at an obtuse angle forming an intermediate portion 92. Finally, each member of the pair of upstanding tubular support members 65 bends in the opposite direction, thereby forming the handle portion 30.

As is generally known in the art, the frame 15 is supported by a plurality of wheel assemblies 20, 25. Each of the pair of front wheel assemblies 20 includes a castor 94, a U-shaped bracket 95, and a wheel 98. As is known in the art, each bracket 95 for a respective castor 94 is adapted to pivot about a generally vertical axis, thereby allowing the castor 94 to swivel. In addition, each bracket 95 includes a shaft (not shown) which extends horizontally through the bracket 95 defining an axis about which the wheel 98 rotates. Each of the pair of rear wheel assemblies 25 includes a rear wheel 105, a first portion 90 of the upstanding tubular support 65, and a shaft 110. The shaft 110 extends horizontally through the rear wheel 105 and the upstanding tubular support 65, thereby providing a connection between the wheel 105 and the support 65 and providing an axis about which the wheel 105 can rotate.

The cart 10, as mentioned above, includes basket 35. The basket 35 can be formed of metal, plastic, or a metal/plastic combination. The entire basket 35 is formed as an open latticework structure or intersecting bar structure. The basket 35 is adapted to be supported by the frame 15 and directly engages upstanding tubular support 65 and the bottom tubular support 75.

In addition, the rear wall 50 of the cart basket 35 includes a pair of leg holes 115 associated with a retractable child seat assembly 120. As known in the art, the retractable child seat assembly 120 is generally formed with a back portion 125 and a seat portion 130. The back portion 125 is generally formed of metal and is pivotally connected to the basket floor 40 where the floor 40 meets the rear wall 50. The seat portion 130 is pivotally connected to the back portion 125 and the rear wall 50 of the basket 35. The pivotal connection allows the seat assembly 120 to be stowed when not in use. The seat assembly 120 is preferably formed of metal or a combination of metal and plastic. In operation, the back portion 125 of the seat assembly 120 can be pushed away from the rear wall 50 of the cart basket 35, thereby placing the seat assembly 120 in an open position. When in the open position, the seat assembly 120 can hold a child or a shopper's personal items (not shown). When not in use, the back portion 125 of the seat assembly 120 can be pulled towards the rear wall 50 of the cart basket 35, thereby placing the seat assembly 120 in a stowed position. By placing the seat assembly 120 in a stowed position, a shopper can free up additional space in the cart basket 35. Since the structure and function of the retractable child seat assembly 120 is widely known in the art, the assembly will not be further discussed.

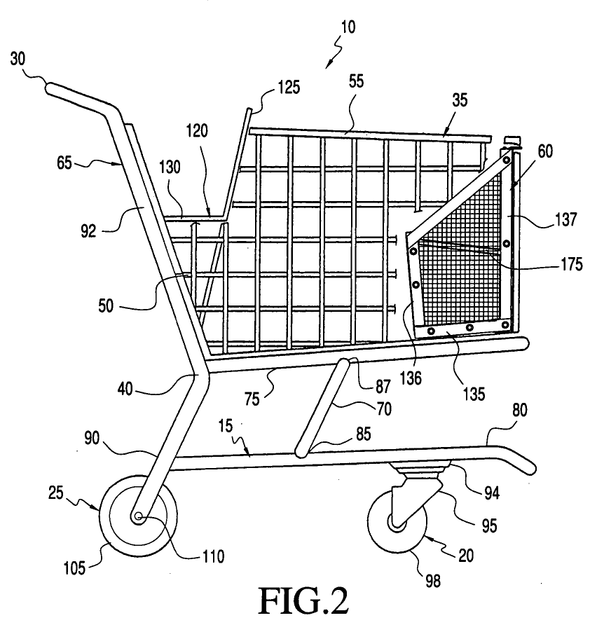

Referring now to FIGS. 1-5, the folding storage assembly 60 is positioned adjacent to the front wall 45 of the cart basket 35. The folding storage assembly 60 comprises a first panel 135, a second panel 136, and a third panel 137. Each panel is preferably formed of plastic in an open latticework structure 140 defined by multiple intersecting web portions. However, other materials and configurations may be used to form the panels.

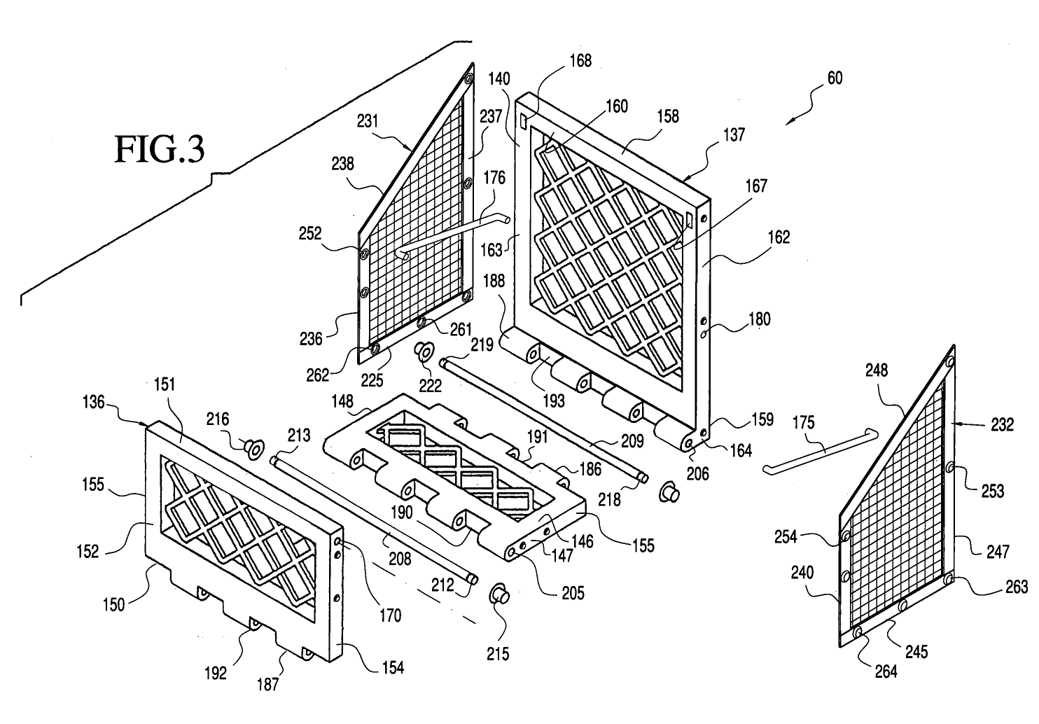

Turning now to FIG. 3, there is shown an exploded view of the folding storage assembly 60. The first panel 135 has a first end 143, a second end 144, a first surface 145, a second surface 146, and a first side 147 and a second side 148. The second panel 136 has a first end 150, a second end 151, a first surface 152, a second surface 153, and a first side 154 and a second side 155. Similarly, the third panel 137 includes a first end 158, a second end 159, a first surface 160, a second surface 161, and a first side 162 and a second side 163. In addition, the second end 159 of the third panel includes a foot 164 which extends perpendicularly to the first surface 160.

The first panel 135 and the second panel 136 are preferably each in the shape of a rectangle. The width of each panel is identical to the width of the other panels. However, the length of the third panel 137 may be equal to the combined length of the sides 147 and 154 of the first 135 and second 136 panels respectively, as shown in FIG. 5, or the length of the third panel 137 may be adjusted to be longer or shorter than the combined length of the sides 147 and 154 depending on the size of the cart basket 35 and its desired use. For example, the panels 135, 136, 137 may be sized to hold a gallon of milk or a carton of 18 eggs.

Further, the second panel 136 includes a pair of projections (not shown) for insertion into a pair of apertures 167. The projections are located along the second surface 153 of the second panel 136, near the second end portion 151. In addition, the second panel 136 includes a pair of opposed openings 170 for receiving connection members 175 and 176. One opening of the pair of openings 170 is located along each of the sides 154 and 155 of the second panel 136. The third panel 137 includes the pair of apertures 167 for receiving the pair of projections 165, wherein the pair of apertures 167 is positioned along the first surface 160 of the third panel 137, near the first end portion 158. The third panel 137 also includes a pair of openings 180 for receiving the connection members 175 and 176, wherein one opening of the pair of openings 180 is positioned on each of the sides 162 and 163 of the third panel 137, midway between the first 158 and second end portions 159.

As shown in FIG. 3, the panels of the folding storable assembly 60 are adapted to be interconnected. The first 143 and second end 144 portions of the first panel 135 each include a plurality of cylinders 185 and 186 alternating with a plurality of gaps 190 and 191. The first end 150 of the second panel 136 includes a plurality of cylinders 187 and a plurality of gaps 192. The plurality of cylinders 187 and is positioned to fit into a corresponding plurality of gaps 190 on the second end 144 of the first panel 135, thereby allowing an interlocking connection between the first 135 and second 136 panels, as further discussed below. Similarly, the horizontal foot 164 of the third panel 137 includes a plurality of cylinders 188 and a plurality of gaps 193 for joining with the plurality of cylinders 186 and gaps 191 on the first end 143 of the first panel 135, thereby allowing an interlocking connection between the first 135 and third 137 panels, as further discussed below.

When the panels (135, 136 and 137) are aligned, as shown generally in FIGS. 3-5, the pluralities of cylinders (185-188) form elongated cylinders 200 and 201 with apertures 205 and 206 therein. Elongated members 208 and 209 are inserted into apertures 205 and 206 to further secure the elongated cylinders 200 and 201. Elongated member 208 includes grooves 212 and 213 for receiving end caps 215 and 216. Similarly, elongated member 209 includes grooves 218 and 219 for receiving end caps 221 and 222. The end caps 215, 216, 221, and 222 are positioned to hold the elongated members 208 and 209 in the corresponding elongated cylinders 200 and 201. Specifically, one end cap is snapped into the groove at each end of each elongated member.

As can best be seen in FIG. 3, first and second flexible side panels 231 and 232 are provided one on each side of the folding assembly 60. The first flexible side panel 231 is formed of an outer frame 233 and a central flexible portion 234 which is preferably formed of netting. The outer frame 233 includes a first framing beam 235 which generally follows the second side 148 of the first panel 135. A second framing beam 236 is attached to the first framing beam 235 and generally follows the second side 155 of the second panel 136. A third framing beam 237 is attached to the first framing beam 235 and generally follows the second side 163 of the third panel 137. A fourth framing beam 238 extends between the second framing beam 236 and the third framing beam 237 in order to complete the outer periphery of the first flexible side panel 231.

In a similar manner, the second flexible panel 232 is also formed with an outer peripheral frame 240 and a central flexible portion 241 which is preferably formed of a netting. The outer frame 240 includes a first framing beam 243 which generally follows along the first side 147 of the first panel 135. A second framing beam 245 is attached to the first framing beam 243 and generally follows the first side 154 of the second panel 136. A third framing beam 247 is attached to the first framing beam 245 and generally follows the first side 162 of the third panel 137. A fourth framing beam 248 extends between the second 245 and third framing beam 247 thus forming the outer periphery of the second side panel 232.

A plurality of snap-type connectors 250 are provided in each of the panels 231 and 232 in order to fasten them to the first 135, second 136 and third panels 137. The snap-type connectors 250 cooperate with receiving member 251 mounted on panels 231, 232. Since these flexible side panels 231, 232 are on the outside of all other components of the flexible storage assembly 60, they be easily removed and replaced by simply pulling the flexible panels 231, 232 away from the rest of the folding storage assembly 60 to release the snap connectors 250. Alternatively, the flexible panels 231, 232 may be securely fastened to the first 135, second 136, and third panels 137 by screws (not shown) passing through grommet holes in the outer frame 240. Indeed any similar type of fastener will do so long as the flexible panels 231, 232 are held in place so as to prevent items from falling out of the assembly 60.

When in an open position, as shown in FIGS. 1, 2 and 4, the folding storage assembly 60 forms a J-shape. The first panel 135 lies parallel with the basket floor 40 and the first surface 145 of the first panel 135 is in continuous contact with the basket floor 40. The second panel 136 extends vertically from the second end 144 of the first panel 135. Similarly, the third panel 137 extends vertically from the first end 143 of the first panel 135. The third panel 137 generally lies flush with the front wall 45 of the cart basket 35. First flexible panel; 231 and second flexible panel 232 adopt a generally flat configuration. As such, the flexible panels 231, 232 will form side walls to prevent small items from falling out of the storage assembly 60 as it forms its J-type shape. As shown in FIG. 1, a plurality of fastening members 285 may be used to secure the third panel 137 to the front wall 45. Preferably, the fastening members 285 are plastic tie wraps, however, the plurality of fastening members 285 may also be standard clips, snaps, or the like.

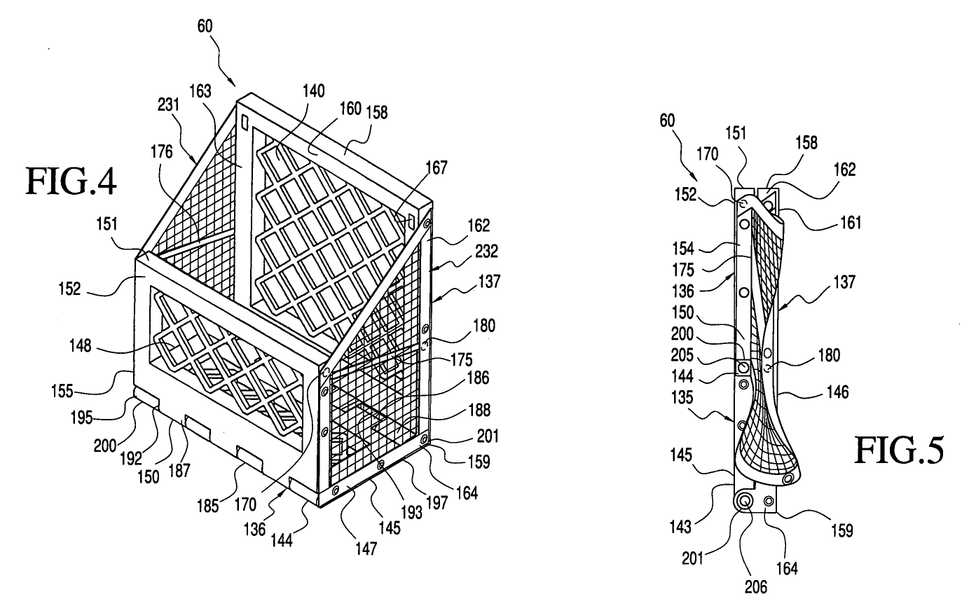

The open position of the folding storage assembly 60 is maintained with connection members 175 and 176, as best seen in FIG. 4. As previously discussed, the side ends 154 and 162 of the second 136 and third 137 panels include openings 170 and 180 for receiving connection member 175. Similarly, the side ends 155 and 163 of the second 136 and third 137 panels include openings (not shown) for receiving connection member 176. Connection members 175 and 176 are preferably rod shaped and are pivotally connected to the second 136 and third 137 panels, thereby allowing movement of the first 135 and second 136 panels relative to the third panel 137.

As shown in FIG. 5, the folding storage assembly 60 is capable of folding to a stowed position. When moving from an open position to a stowed position, the first panel 135 pivots relative to the third panel 137 and the second panel 136 is guided by the connection members 175 and 176. More specifically, the second surface 146 of the first panel 135 pivots towards the first surface 160 of the third panel 137 until the surfaces are in contact with each other. As the first panel 135 pivots, the second panel 136 is guided along an arc by the connection members 175 and 176 until the second panel 136 is stacked above the first panel 135 and the second surface 153 of the second panel 136 is in contact with the first surface 160 of the third panel 137. Flexible panels 231 and 232 adopt a folded configuration when the folding storage assembly 60 is in its stowed position.

The folding storage assembly 60 is held in a stowed position by a detent mechanism (not shown). As previously described, the second panel 136 includes the pair of projections for insertion into the pair of apertures 167 on the third panel 137. When in the stowed position, the pair of projections on the second panel 136 are received into the pair of apertures 167 on the third panel 137, thereby securing the folding storage assembly 60 in a stowed position.

The folding storage assembly 60 is manufactured to easily retrofit existing shopping carts. During assembly, the first panel 135 is connected to the second panel 136 by inserting the plurality of cylinders 187 on the first end 150 of the second panel 136 into the corresponding plurality of gaps 190 on the second end 144 of the first panel 135, thereby forming the elongated cylinder 200. Similarly, the third panel 137 is connected to the first panel 135 by inserting the plurality of cylinders 188 on the second end 159 of the third panel 137 into the corresponding plurality of gaps 191 on the first end 143 of the first panel 135, thereby forming the elongated cylinder 201. To secure the elongated cylinders 200 and 201, elongated members 208 and 209 are inserted into apertures 205 and 206 of the elongated cylinders 200 and 201, respectively. In addition, end caps 215, 216, 221 and 222 are positioned on elongated members 208 and 209 to hold the elongated members 208 and 209 within the elongated cylinders 200 and 201. Next, the flexible side panels 231, 232 are snapped in place onto receiving members 251. The assembly 60 is then placed in the shopping cart basket 35. The second surface 161 of the third panel 137 of the folding storage assembly 60 is placed flush against the front wall 45 of the cart basket 35. Finally, the plurality of fastening members 285 are added to hold the third panel 137 of the folding storage assembly 60 secure along the front wall 45 of the cart basket 35.

In operation, the folding storage assembly 60 can be placed in an in-use position in order to hold small items or fragile items, such as produce. The second panel 136 of the assembly 60 can be pulled down by a shopper, thereby causing the first 135 and second 136 panel to be pivoted into an open position. Naturally, the flexible side panels 231, 232 adapt to their flattened configuration so as to prevent stored items from falling therethrough. The shopper may then use the storage assembly 60 to hold fragile items and protect them from heavier items in the cart basket 35. In this configuration of course the flexible first side panel 231 and flexible second side panel 232 act to retain items within the folding storage assembly 60 so that they do not fall out either side of the storage assembly 60. When the shopper needs to make additional room in the cart basket 35 to hold large items, the folding storage assembly 60 can easily be place in a stowed position. When a shopper pulls up on the second panel 136 of the assembly 60, the first 135 and second 136 panels pivot to an upright position. The pair of projections on the second panel 136 are received into the pair of apertures 167 on the third panel 137, thereby holding the assembly 60 in a stowed position.

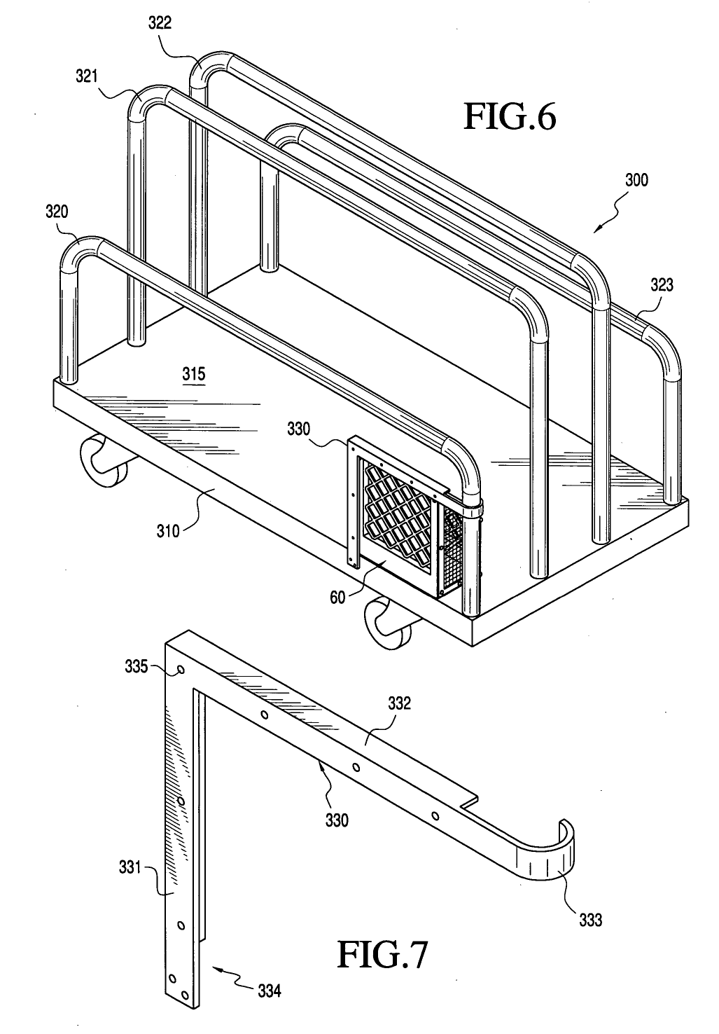

Turning now to FIG. 6, there is shown the folding storage assembly 60 mounted on a lumber cart 300. The lumber cart 300 includes a base frame 310 and a floor 315 formed on the base frame 310. Extending upwardly from the floor are outer support rails 320 and 323 and inner support rails 321 and 322. The folding storage assembly 60 is shown with a support bracket 330. Preferably, the storage assembly 60 is mounted flush with support rail 320 but it may also be mounted so that it is spaced from rail 320 if desired.

As can best be seen in FIG. 7, a close-up view of the support bracket 330 is shown. The support bracket 330 includes a base portion 331, a horizontal support portion 332 and a fastener member 333 in the shape of a hook. The base portion 331 is formed with an L-shaped cross-section to increase rigidity and strength. The support portion 332 is also formed with an L-shape cross-section. One side of the L is provided with holes 335 which allow for fastener members to be placed therethrough to connect the support bracket 330 to the third panel 137 of the folding storage assembly 60. An end of the base portion has holes 342 that allow for fasteners to pass therethrough and into the base 310.

In operation, the folding storage assembly 60 may simply be mounted on one of the bars 320 of the lumber cart 300. In an open configuration, the folding storage assembly 60 may support small items and by virtue of the flexible side panels 231, 232, keeping such items from falling out. Also, of course, the storage assembly 60 may be placed in a stowed configuration so as to take up less room and allow for lumber to be placed between outer rail 320 and inner rail 321.

Although described with reference to preferred embodiments, it should be readily understood that various changes and/or modifications could be made to the invention without departing from the spirit thereof. For example, the folding storage assembly 60 has been described in reference to a shopping cart 10 and a lumber cart 300, but the assembly 60 could be mounted in any type of cart or on any type of support and is intended to be a self contained unit. In any event, the invention is only intended to be limited by the scope of the following claims.

1. In a cart for transporting items comprising: a frame, a floor, wheels supporting said frame, a folding storage assembly for holding items, said folding storage assembly comprising:
a first panel having first and second end portions and first and second sides, said first end portion being pivotally mounted in the cart;
a second panel having first and second end portions and first and second sides, said first end portion of said second panel being pivotally connected to the second end portion of the first panel;
a flexible side panel attached to the first side of the first panel and the first side of the second panel such that when said folding storage assembly moves between an in-use position, wherein said first panel extends along the floor of the cart, the second panel projects upward from the second main portion of the first panel and the flexible panel extends between the first and second panels, and a stowed position, wherein the first and second panels are positioned substantially flush with each other and the flexible panel forms a folded configuration; and
a first support bracket having a base portion and a support portion, the base portion being attached to the first panel and the support portion being attached to the base portion, said bracket also including a fastener member for fastening the support bracket to the cart.

2. The folding storage assembly of claim 1, wherein said flexible side panel is secured to the first and second panel with snap connectors.

3. The folding storage assembly of claim 1, wherein said flexible side panel is formed of a netting.

4. The folding storage assembly of claim 1, further comprising: a third panel having first and second end portions and first and second sides, the second end portion of said third panel being pivotally connected to the first end portion of the first panel and wherein said flexible side panel is attached to the first side of the third panel.

5. The folding storage assembly of claim 4, wherein said flexible side panel is formed of a netting.

6. The folding storage assembly of claim 5, wherein said flexible side panel is secured to the first and second panel with snap connectors.

7. The folding storage assembly of claim 1, wherein the fastening member of the first support bracket is in the shape of a hook.

8. The folding storage assembly of claim 7, wherein said first support bracket is in the shape of an L.

9. The folding storage assembly of claim 1, further comprising: a second support bracket having a base portion and a support portion, the base portion being attached to the first panel and the support portion being attached to the base portion and including a fastening member for fastening the support bracket to the cart.

10. A folding storage assembly comprising:
a first panel having first and second end portions and first and second sides, said first end portion being adapted to be pivotally mounted in a cart;
a second panel having first and second end portions and first and second sides, the first end portion of said second panel being pivotally connected to the second end portion of the first panel;
a flexible side panel attached to the first side of the first panel and the first side of the second panel such that when said folding storage assembly moves between an in-use position, wherein said first panel extends along the floor of the cart and the second panel projects upward from the second main portion of the first panel, the flexible panel extends between the first and second panels and a stowed position, wherein the first and second panels are positioned substantially flush with each other and the flexible panel forms a folded configuration.

11. The folding storage assembly of claim 10, wherein said flexible side panel is secured to the first and second panel with snap connectors.

12. The folding storage assembly of claim 10, wherein said flexible side panel is formed of a netting.

13. The folding storage assembly of claim 10, further comprising: a third panel having first and second end portions and first and second sides, the second end portion of said third panel being pivotally connected to the first end portion of the first panel and wherein said flexible side panel is attached to the first side of the third panel.

14. The folding storage assembly of claim 13, wherein said flexible side panel is secured to the first and second panel with snap connectors.

15. The folding storage assembly of claim 13, wherein said flexible side panel is formed of a netting.

16. A folding storage assembly comprising:
a first panel having first and second end portions and first and second sides, said first end portion being adapted to be pivotally mounted in a cart;
a second panel having first and second end portions and first and second sides, the first end portion of said second panel being pivotally connected to the second end portion of the first panel;
a first support bracket having a base portion and a support portion, the base portion being attached to the first panel and the support portion being attached to the base portion, said bracket also including a fastener member for fastening the support bracket to the cart.

17. The folding storage assembly of claim 16, wherein the fastening member of the first support bracket is in the shape of a hook.

18. The folding storage assembly of claim 17, wherein said first support bracket is in the shape of an L.

19. The folding storage assembly of claim 16, further comprising: a second support bracket having a base portion and a support portion, the base portion being attached to the first panel and the support portion being attached to the base portion and including a fastening member for fastening the support bracket to the cart.
